(19) United States
(12) Patent Application Publication
(10) Pub. No.: US 2005/0083183 A1
(43) Pub. Date: Apr. 21, 2005

(54) VEHICLE COURTEOUS MESSAGE DISPLAY

(76) Inventors: DU CAO, Windsor (CA); LI YU, Windsor (CA)

Correspondence Address: DU CAO, 3232 NORTHWAY AVE, WINDSON, ON, N9E 4T, CA

(21) Appl. No.: 10/711,655

(22) Filed: Sep. 29, 2004

Related U.S. Application Data
(60) Provisional application No. 60/506,571, filed on Sep. 29, 2003.

(51) Int. Cl. B60R 25/10

(52) U.S. Cl. 340/426.13

(57) ABSTRACT

A device, vehicle courteous message display, is designed to express a driver's response when the need arises. Mainly, it includes a small remote control and a LED electronic display panel box. The small and handy remote control can either program or play a message. The means of message input or edit is similar with that of a cell phone message operation. Programmed words, phrases, signs, and numbers are stored in read/write memories of the display panel box. A message or a group of messages can be instantly displayed with a press of single button. The display panel can be easily placed on/near the rear window of an automobile with suction cups, double-side foam tape or Velcro.

### FIELD OF INVENTION

The field of invention relates generally to one-way visual communication devices for courteous response and more particularly pertains to a new and improved vehicle message display that is a simplified device and easy operation as well as installation.

### BACKGROUND OF THE INVENTION

Every so often, a driver may get ahead of and cut into a line of cars or cross a 4 way stop sign when another vehicle yields the right of way. Most vehicles normally yield the right of way when a truck makes a turn. It is a kind of courtesy for a driver to express his appreciation or excuse to another driver in a certain way. Conventionally, a driver may raise his hand or turn on and off his turn signal lamps to express his thanks. Unfortunately, other drivers, who did the favor, may not see or understand his meaning. Furthermore, an appropriate message can be shown for different situations. Messages, such as “BABY ON BOARD” and “NEW DRIVER” will alert other drivers to be more cautious around your vehicle. It may be necessary for one to get help in case of an emergency. Using a message such as “PLEASE HELP” or PLEASE CALL 911” will be immensely useful.

The visual communication devices are revealed in the prior art. Generally, these involve safe travel, commercial message and two-way communication. There are typically three types of device. One is a simple device connected and activated together with signals in the vehicle electrical system for a display of fixed signs or messages, such as U.S. Pat. No. 5,426,414 to Flatin. Obviously, a driver can only show a few fixed signs or messages while a signal is turned on.

An erasable message board and/or illuminative message plate are generally used for another one-way visual communication device. A typical example of this invention is quoted by U.S. Pat. No. 6,401,374 to Bahmad. All of these devices are severely limited in the amount of information that can be displayed.

The third one, which is close to the present invention, is a digital display device with a matrix of light-emitting elements. The initial idea was put forward by U.S. Pat. No. 4,361,828 to Hose. The incandescent lamps are used to form the matrix of light-emitting elements for a message display in this invention.

U.S. Pat. No. 4,949,071 to Hutchison sets forth a vehicle communication device with a mercury switch. The control unit includes a series of selectively removable signal cartridges.

U.S. Pat. No. 5,053,746 to Taneo sets forth a vehicular communication device includes a visual display panel comprising a matrix of LED light members. A vehicular display device for securement to a self-propelled vehicle to overlie the vehicle rear bumper and mounted forwardly of the forward edge of a trunk assembly of the vehicle.

U.S. Pat. No. 5,500,638 to George sets forth a vehicular goodwill message system for displaying messages comprising a plurality of logic gates for receiving at least four timed signals and for supplying at least seven output signals and for electrically communicating with a timing means and a display means. There is a limitation of displaying message for both timing and display choice. The logic circuit is old style and too complicated.

U.S. Pat. No. 6,300,870 to Nelson sets forth a complex vehicle communicating system consisting of an onboard microelectronic miniature computer unit installed in the interior of a vehicle and a light emitting polymer (LEP) display panel unit.

U.S. Pat. No. 6,553,285 to Bahmad sets forth a message conveying system with a remote control unit adapted for securement to a dashboard of the motor vehicle and complicated mounting device fastened on the dashboard near the rear window. This invention reveals a good concept without supplying the means of massage operation. The system of this invention does not offer the method how to input or edit a message in the system. The remote control unit, which is attached on a dashboard of the motor vehicle, is not handy for a driver.

With regard to a courteous message, there may be one U.S. Pat. No. 5,578,986 to Hiroshi dedicated to this kind of courteous expression. It relates to an on-off signal, which has a predetermined period to flash turn signal lamps, to express a driver's appreciation to a succeeding car. Even such action is doubtful to convey the intention of the driver with certainty. What is needed is a device proposed and dedicated to a clear expression of the courteous message.

Thus, it may be necessary for a new and improved vehicular message display for a simplified device and easy operation as well as installation.

While our world is going at such a fast pace, the present invention helps to cut down on road rage. It is quickly becoming one of the best ways to help tone down on preventable traffic accidents all the while, making a following driver feel appreciated.

### BRIEF SUMMARY OF THE INVENTION

Therefore, it is an object of the present invention to provide a simplified device and easy operation as well as installation.

A device, vehicle courteous message display, is designed for a driver's courteous response to other people. Mainly, it includes a remote control and an electronic LED display panel box. The small and handy remote control may be put anywhere within easy access to the driver. The preprogrammed words, phrases, signs, or numbers are stored in a read/write memory of the LED display panel. Driver can simply press a button to express each courteous message displayed through a visual display panel. The display panel is usually seated on a dashboard behind the rear sit with two pieces of double side foam tape or Velcro. In the present invention, the display panel can also be directly attached on the rear or side window of an automobile because of its unique design for a light weight LED display panel box with four suction cups.

A driver can express his courteous response to other people with simple phrases, such as “THANKS” or “SORRY” when needed. A driver may also express any other message by programming what he wants to say. The present invention allows sets of signs, phrases, words, or numbers to be easily programmed and edited by utilizing the small keypad of the remote control. The input and edit of a message are similar to a message entry of a cell phone operation, which eliminates any complicated and expensive computing system for the message operation in the previous arts.

### BRIEF DESCRIPTION OF THE DRAWING

FIG. 1 is the concept view of an application for the present invention.

FIG. 2 is the sketch map for the assembly of the vehicle courteous message display.

FIG. 3 is the photo picture showing the practical application of its installation.

FIG. 4 is the photo picture for the assembly of the vehicle courteous message display.

### DESCRIPTION OF THE PREFERRED EMBODIMENT

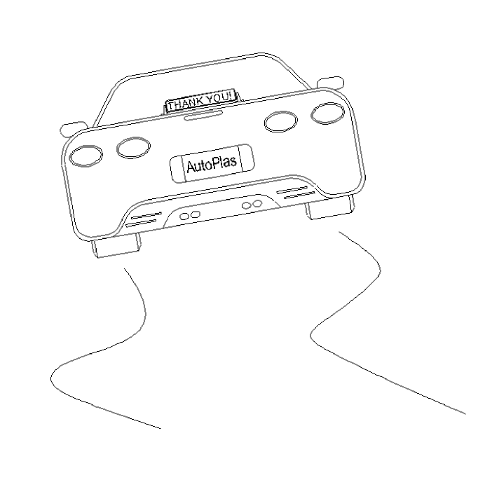

The present invention provides a driver with a chance to express his response to another driver when he/she yields the right of way and also gives him the chance to communicate his regret when he cuts another driver. The message can be a simple “THANKS” or “SORRY” as shown in FIG. 1 when needed, or he can also express himself by displaying a message that he has programmed by himself.

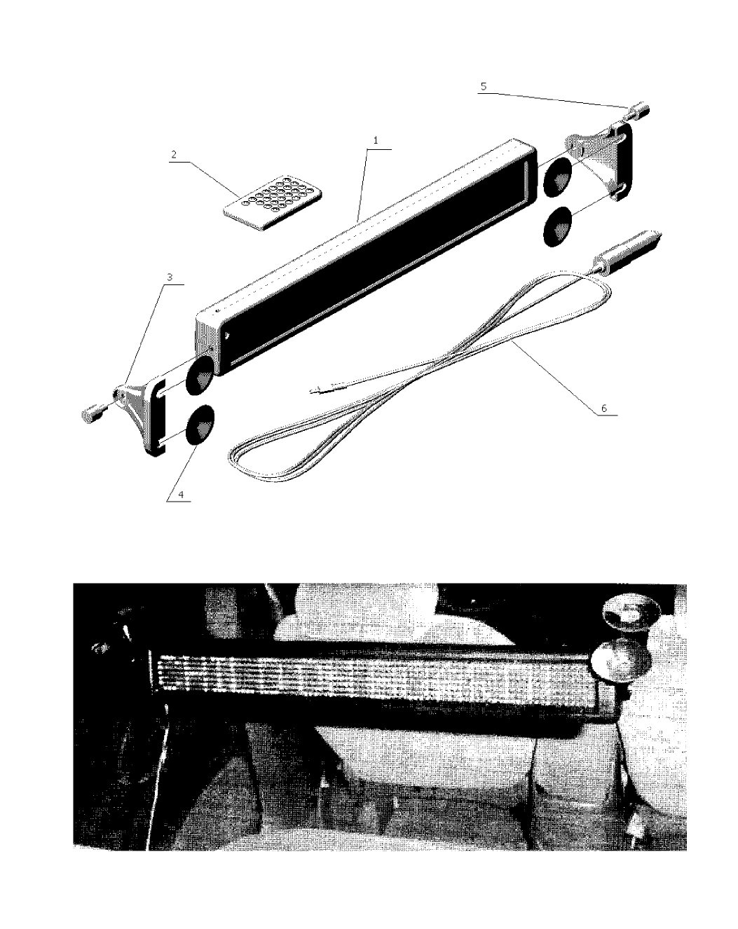

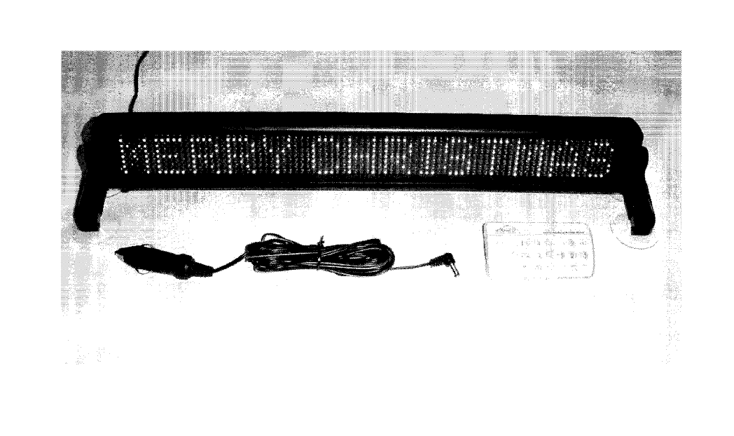

As shown in FIG. 2 and FIG. 4, a device of vehicle courteous message display includes an electronic LED display panel box (item 1), a remote control (item 2), a pair of brackets (item 3), four suction cups (item 4), two thumb screws (item 5), and a power cord (item 6) connecting to the 12V DC car cigarette lighter. The configuration of LED display panel box mainly comprises a signal receiving device, read/write memories and a visual display panel with a set of LED (Light Emitting Diode) matrix.

Both message input and edit can be completed with this small remote control. The key layout pattern on the remote control is similar with that of a cell phone. Thus, the means of message operation is almost the same as that of a cell phone. Just like a cell phone key layout pattern, each button represents a number and three or more letters. It acts as a functional key for the input or edit of a message in a programming condition. The remote control sends an electronic signal of triggering pulse to the LED display panel box while programming or editing. The signal can be transmitted through wire or wireless transportation. Sets of words, signs, or numbers are sent and stored in the memories of the LED display panel box. Then, the preprogrammed message can be actuated and displayed on the display panel by simply press a number key on the remote control. Each number of a button represents a specific message in a display mode. An electronic LED lighting number on the backside of the LED display panel box, which a driver can read through the rearview mirror, shows when and which courteous message is displayed. There can also be a small (e.g. LCD) screen on the remote control to indicate the same message shown on the display panel for the driver who conducts it.

Here is the installation procedure: the four suction cups (item 4) are pushed into notches on the bottom of brackets. The two thumbscrews (item 5) or socket head cap screws attach brackets to each end of the LED display panel box. Then, the LED display panel box will be attached on the window glass with suction cups. Finally, the power cord is plugged in both LED display panel box and a car cigarette lighter to run a default message automatically. The display view angle can be easily adjusted at any degree. There is almost no tool needed for the installation.

Functionally, multiple choices for a message display, such as page-by-page displaying with timing selection and scrolling with different speeds are supplied in the present invention. In order to minimize the LED brightness that may be a distraction to another following driver, the LED display panel box may be equipped with a light intensity sensor to dim the display brightness automatically after dark. It provides different levels of visual intensity for a LED message display.

1. A device, vehicle courteous message display, primarily includes a remote control with a small keypad and an electronic LED display panel box. The LED display panel box mainly comprises a single receiving device, read/write memories, and a visual display panel with a LED (Light Emitting Diode) matrix. When the remote control sends an electronic signal, triggering a pulse to the LED display panel box, there are two intents of the signal: either to program a new message or to display a programmed message. Sets of signs, phrases, words, and numbers can be programmed and edited with a small remote control and saved in the memory of the LED display panel box. Preprogrammed message can be actuated and displayed on the LED display panel with the same remote control.

2. A device, vehicle courteous message display, according to claim 1, wherein multiple choices for a message display, such as page-by-page displaying with timing selection or scrolling with different speeds are supplied.

3. A device, vehicle courteous message display, according to claim 1, wherein the small and handy remote control may be put anywhere within easy access to the driver. The layout of the keypad on the remote control is designed to be similar with a keypad of a cellular phone. Each button represents a few characters when programming or editing a message. On the other hand, the button also acts as the number of a specific preprogrammed message in the displaying mode. LED lighting number on the backside of LED display panel box is used to show a driver when and which message is displayed. There may be a small display screen like LCD on the remote control to show the same message as that displayed on the display panel. The control signal can be transmitted through wire or wireless transportation.

4. A device, vehicle courteous message display, according to claim 1, wherein its method may be embodied in original vehicle manufacturing or in an aftermarket product in a manner so that the driver may easily determine.

5. A device, vehicle courteous message display, according to claim 1, wherein the power used for both remote control and the electronic LED display panel box can be either battery or power outlet supplied in a vehicle. Voltage adaptor can also be used when needed.

6. A device, vehicle courteous message display, according to claim 1, wherein the LED display panel box can be seated on the dashboard behind of rear window with two pieces of double side foam tape or Velcro. Otherwise, four small suction cups are used to attach it on the rear or side window of an automobile.

7. A device, vehicle courteous message display, according to claim 1, wherein the means of the display can be made of LED (Light Emitting Diode) or any other light-emitting elements. An array of light emitting elements can be laid out in multi-line or other patterns.

8. A device, vehicle courteous message display, according to claim 6, wherein light intensity sensor, which provide different levels of visual intensity for a display, may be equipped.
